(19) United States
(12) Patent Application Publication
(10) Pub. No.: US 2009/0084140 A1
(43) Pub. Date: Apr. 2, 2009

(54) GLASS FURNACE FLUE GAS TO HEAT GLASSMAKING MATERIAL AND OXIDANT

(76) Inventor: HISASHI KOBAYASHI, Putnam Valley, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/212,043

(22) Filed: Sep. 17, 2008

Related U.S. Application Data
(60) Provisional application No. 60/976,156, filed on Sep. 28, 2007.

(51) Int. Cl. C03B 5/16

(52) U.S. Cl. 65/134.4

(57) ABSTRACT

Heat in a stream of combustion products obtained from a glassmelting furnace heated by oxy-fuel combustion is passed to incoming glassmaking materials in a heat exchanger without requiring reduction of the temperature of the stream yet without causing softening of the glassmaking material.

### CROSS-REFERENCE TO RELATED APPLICATION

The present invention claims priority to U.S. provisional patent application Ser. No. 60/976,156, filed Sep. 28, 2007, the entire contents of which are incorporated herein by reference in its entirety.

### FIELD OF THE INVENTION

The present invention relates to the production of glass, and more particularly to the heating of glassmaking material by heat exchange with combustion products (flue gas) formed in the combustion that is carried out to generate heat for melting the glassmaking material.

### BACKGROUND OF THE INVENTION

Conventional glassmaking methods require establishing in a glassmelting furnace temperatures that are high enough to melt the glassmaking material (by which is meant one or more materials such as sand, soda ash, limestone, dolomite, feldspar, rouge, which are collectively known as “batch” and/or broken, scrap and recycled glass, known as “cullet”). The required high temperature is generally obtained by combustion of hydrocarbon fuel such as natural gas. The combustion produces gaseous combustion products, also known as flue gas. Even in glassmaking equipment that achieves a relatively high efficiency of heat transfer from the combustion to the glassmaking materials to be melted, the combustion products that exit the melting vessel typically have a temperature well in excess of 2000° F., typically in a range of 2600 to 2950 F., and thus represent a considerable waste of energy that is generated in the glassmaking operations unless that heat energy can be at least partially recovered from the combustion products. The prior art has addressed this problem by using flue gas-to-air heat exchangers, often of the types known as recuperators or regenerators. In a conventional air fired recuperative or regenerative furnace, waste heat in the flue gas is partially recovered in the heat exchanger by preheating the incoming combustion air and the exit temperature of the flue gas after passing through the regenerative heat exchanger is reduced to about 800 to 1000° F. and that after passing through the recuperative heat exchanger is reduced to about 1000 to 1600° F.

Combustion of the hydrocarbon fuel with gaseous oxidant having an oxygen content higher than that of air (which is 20.9 vol. %) (known as “oxy-fuel combustion”) provides to the glassmaking operation numerous advantages compared to combustion of the fuel with air. Among those advantages are higher flame temperature and higher available heat without requiring oxidant preheating, which affords higher heat transfer and shorter melting times, and reduced overall volume of the gaseous combustion products that exit the glassmelting furnace, which affords a reduction in the size of the gas-handling equipment that is needed. The combustion products that exit the glassmelting furnace typically have a temperature well in excess of 2000° F., typically in a range of 2500 to 2900 F, and thus represent a considerable waste of energy in spite of its reduced volume. Thus, the gaseous combustion products of oxy-fuel combustion can contain even more heat energy, compared to the large volume combustion products of conventional air-fired combustion with regenerators, which should be used to advantage to improve the overall energy efficiency of the glassmaking operation.

While the glassmaking art is aware of using heat in the hot gaseous combustion products from the glassmelting furnace to preheat incoming glassmaking material which is to be melted in the manufacture of the glass, the heretofore known technology has believed that the temperature of the hot combustion products should not exceed about 1000 to 1300° F. as it commences heat exchange with the glassmaking material. This maximum temperature is imposed by considerations of the capability of the materials from which the heat exchanger is constructed to withstand higher temperatures, and considerations of the tendency of the glassmaking material to begin to soften and become adherent (or “sticky”) if it becomes too hot during the heat exchange step, leading to reduced throughput and even plugging of the heat exchanger passages. The temperature at which the glassmaking material becomes adherent or sticky depends on the batch composition and the material in contact with the glassmaking material and is believed to be in a range between 1000 and 1300° F. for a common batch to make soda lime glass for bottles and windows. In a conventional air fired regenerative furnace, the flue gas exit temperature after the regenerators is about 800 to 1000° F. and there is no need to cool down the flue gas prior to a batch/cullet preheater. Several commercial container glass furnaces have adopted batch/cullet preheaters to heat the glassmaking material by utilize the waste heat contained the large volume of flue gas coming out of the regenerator. Because of the relatively low temperature of flue gas, however, the maximum preheat temperatures achieved by this method was limited to about 600° F. In addition the physical size of the commercially available batch/cullet preheater is very large in order to exchange heat with the large volume of flue gas, making it economically unattractive.

When the gaseous combustion products exiting the glassmelting furnace are at high temperatures such as the temperatures obtained by oxy-fuel combustion, the conventional belief has been that they need to be cooled to the range of from 1000 to 1300° F. before heat exchange with the incoming glassmaking materials can commence. Numerous examples exist showing the prior art's belief that the temperature of the flue gas must be reduced before the flue gas is used to heat incoming glassmaking materials. Such examples include C. P. Ross et al., “Glass Melting Technology: A Technical and Economic Assessment”, Glass Manufacturing Industry Council, August 2004, pp. 73-80; G. Lubitz et al., “Oxy-fuel Fired Furnace in Combination with Batch and Cullet Preheating”, presented at NOVEM Energy Efficiency in Glass Industry Workshop (2000), pp. 69-84; U.S. Pat. No. 5,412,882; U.S. Pat. No. 5,526,580; and U.S. Pat. No. 5,807,418.

However, reducing the temperature of this stream of combustion products by adding to it a gaseous diluent such as air, and/or spraying a cooling liquid such as water into the stream, is disadvantageous as such approaches reduce the amount of recoverable heat remaining in the gaseous combustion products, increase the size of the gas handling equipment that is needed, and adds additional equipment and process expense.

### BRIEF SUMMARY OF THE INVENTION

One aspect of the invention is a glassmelting method comprising
(A) passing heated glassmaking material into a glassmelting furnace;
(B) combusting fuel with gaseous oxidant having an overall average oxygen content of at least 20.9 vol. % oxygen to produce heat for melting said heated glassmaking material in said glassmelting furnace and produce hot combustion products having a temperature greater than 1800° F.;
(C) obtaining first and second streams of hot combustion products from said furnace;
(D) feeding glassmaking material into a first heat exchange unit comprising a lower end, an upper end, and sides enclosing a heat transfer space between said upper and lower ends so that said glassmaking material descends along the inner surface of a side of said heat exchange unit;
(E) feeding said first stream of combustion products into said first heat exchange unit, wherein the temperature of said hot combustion products entering said heat exchange unit is at least 1800° F., and flowing said hot combustion products through said heat transfer space and out of said heat exchange unit,
   wherein said hot combustion products heat said glassmaking material in said unit by heat exchange at least part of which is radiative heat exchange),
   wherein said hot combustion products do not contact said glassmaking material within said heat transfer space while they are at a temperature at which the glassmaking material would become adherent if it contacts said hot combustion products,
(F) feeding said second stream of combustion products through a second heat exchanger wherein it exchanges heat by indirect heat exchange to said gaseous oxidant; and
(G) providing glassmaking material heated in step (E) as heated glassmaking material that is passed to the furnace in step (A), and providing gaseous oxidant that is heated in step (F) as gaseous oxidant that is combusted in step (A).

As described below, the relative volumes of said first and second streams of combustion products are preferably adjusted so that heat transfer is optimized and so that the first heat exchanger does not receive so much heat load that it overheats.

Another aspect of the invention is a method of modifying a glassmelting furnace, comprising

providing a glassmelting furnace wherein fuel and gaseous oxidant having an oxygen content of at least 20.9 vol. % can be combusted to produce heat for melting glassmaking material in said furnace and produce hot gaseous combustion products, and a first heat exchanger coupled to the glassmelting furnace through which said hot combustion products can pass and through which said gaseous oxidant to be combusted in said furnace can pass and be heated by indirect heat exchange from said hot combustion products;

coupling to said glassmelting furnace a second heat exchanger comprising a lower end, an upper end, and sides enclosing a heat transfer space between said upper and lower ends so that hot combustion products from said furnace can pass through said space and glassmaking material can pass through said space along an inner surface of a side of said space and can then pass into said furnace, wherein said space is of sufficient size that hot combustion products passing through said space heat glassmaking material passing along an inner surface of said sides by radiative heat exchange but do not contact said glassmaking material within said heat transfer space while they are at a temperature at which the glassmaking material would become adherent if it contacts said hot combustion products, and

providing one or more controllable dampers that can alter the volumes of said combustion products that are fed to said first heat exchanger and to said second heat exchanger.

As used herein, that glassmaking material is “adherent” means that when 250 grams of the glassmaking material which is in free-flowing particulate form at room temperature is heated to a given temperature in a metal container made of the same material as the barrier that the material is to flow past and is held at that temperature for 30 minutes and the container is then inverted, at least 1% of the material adheres to the surface of the container; and the temperature at which the material “becomes adherent” is the lowest temperature at which the material is thus “adherent” when it is heated to that temperature.

As used herein, “direct” heat transfer means that there is no barrier or other solid object in the path along which the heat flows.

As used herein, “indirect” heat transfer means heat transfer from one material to another without direct contact between the material from which and to which heat is being transferred.

### BRIEF DESCRIPTION OF THE DRAWINGS

FIG. 1 is a schematic view of glassmaking apparatus with which the method of the present invention can be practiced.

FIG. 2 is a cross-sectional view of a heat exchange unit useful in the practice of the present invention.

FIG. 3 is a plan view of the interior of the heat transfer unit shown in FIG. 2, showing a preferred embodiment thereof.

FIG. 4 is a cross-sectional view of an alternative heat exchange unit useful in the practice of the present invention.

FIG. 5 is a schematic view of glassmaking apparatus useful with the method of the present invention.

FIG. 6 is view of an alternative embodiment of apparatus useful in the present invention.

### DETAILED DESCRIPTION OF THE INVENTION

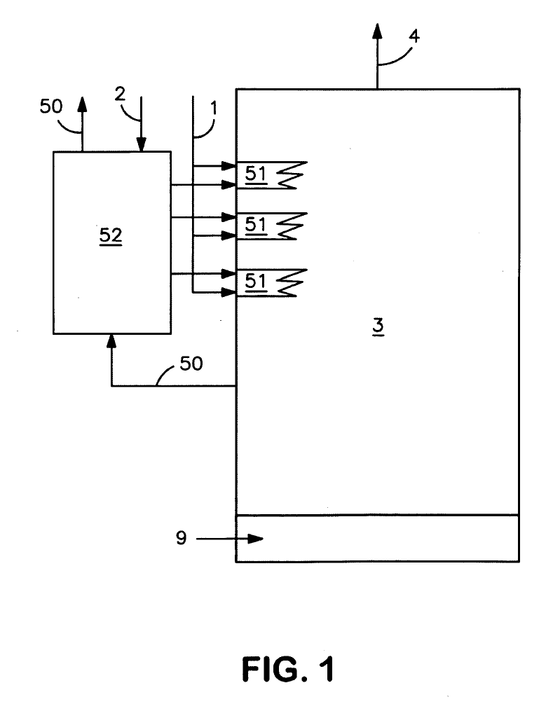

Referring to FIG. 1, fuel stream 1 and gaseous oxidant 2 are fed to glassmelting furnace 3 and combusted therein to generate sufficient heat to melt the glassmaking material present within furnace 3. Stream 4 of molten glass can be recovered from glassmaking furnace 3.

Suitable fuels include any that can be combusted with oxidant (air, oxygen enriched air or oxygen) to generate the required amount of heat of combustion. Preferred fuels include gaseous hydrocarbons, such as natural gas.

The oxidant depicted as stream 2 can be fed as one stream to a solitary burner within furnace 3, but is more often provided as a plurality of streams to each of several burners 51 within furnace 3. Considered over the aggregate of all such gaseous streams, the overall average oxygen content of all streams fed to and combusted in furnace 3 is at least that of air and is higher than 20.9% if oxygen enrichment or oxy-fuel burners are used. The oxygen content can be at least 35 volume percent oxygen, and more preferably at least 50 or even at least 90 volume percent oxygen. That is, the oxygen contents of the oxidant streams fed to different burners may differ from one another, for instance if the operator desires to have some burners (to which a higher oxygen content is fed) burn hotter than other burners. The preferred manner of obtaining a gaseous oxidant stream containing a desired oxygen content is to mix air and a gas having an oxygen content higher than that of air (such as a stream of 90 volume percent oxygen) either upstream from a particular burner or at the burner outlets.

The furnace before and after addition of the radiative heat exchanger described below can be equipped entirely with burners that combust fuel with air, or entirely with burners that combust fuel with oxidant having a higher oxygen content than air, or with burners some of which combust fuel with air and some of which combust fuel with oxidant having a higher oxygen content than air. Furthermore, when as described herein a radiative heat exchanger is added to the furnace, optionally one or more burners can be removed, or added, which combust fuel with air or which combust fuel with oxidant having a higher oxygen content than air.

Combustion of the fuel and oxidant produces hot gaseous combustion products. Some or all of these combustion products are passed through heat exchanger 52 to heat by indirect heat exchange some or all of the incoming oxidant 2 that is to be fed to furnace 3. Heat exchanger 52 represents any type of heat exchanger that performs this function, such as a recuperative heat exchanger. Alternatively, two or more regenerative heat exchangers can be provided, wherein as is well known combustion products are passed through one of the regenerative heat storage beds made of refractory bricks to heat it, and then the flow of combustion products is replaced by a flow of incoming oxidant which is heated by the heated regenerative heat storage bed while the combustion products are passed instead through another regenerative heat storage bed that has previously been cooled by the passage of the oxidant through it.

Glassmaking material referred to as 9 in FIG. 1 is fed to furnace 3 to be melted therein.

One aspect of this invention comprises adding a radiative heat exchanger to exchange heat between hot gaseous combustion products and the glassmaking material to a glassmelting furnace such as is shown in FIG. 1, and another aspect of the invention is the resulting apparatus that comprises first and second heat exchangers as described herein.

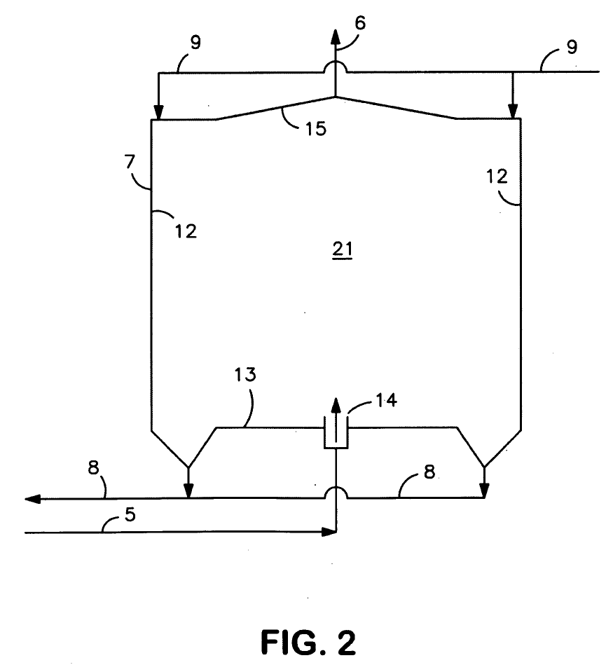

FIG. 2 illustrates one preferred embodiment of heat exchange unit 7. Heat transfer space 21 is defined by lower end 13, upper end 15, and wall 12. Heat exchange unit 7 can have a horizontal cross-sectional shape which is circular, rectangular, or any other geometric configuration, although circular and rectangular, particularly square, are preferred. Thus, wall 12 can be one continuous piece, or can comprise several sides which taken together form wall 12.

Stream 5 of hot combustion products from the glassmelting furnace is fed through one or more inlet nozzles 14 in the lower end 13 of unit 7 into space 21. Advantageously, stream 5 is conveyed to the heat exchange unit 7 in a pipe that has a suitable heat-resistant refractory interior lining that can withstand the high temperature of this stream. Stream 5 as it enters space 21 is at a temperature of at least 1800° F. and may be over 2000° F. or even over 2200° F. and as high as 3000 F. Thus, one advantage of the practice of the present invention is that it can be carried out without requiring any significant reduction in the temperature of the hot combustion products before beginning to transfer heat from the hot combustion products to the glassmaking material. Significantly, no addition of dilution air or other cooling media to stream 5, between the glassmelting furnace and unit 7, is necessary.

Referring again to FIG. 2, stream 9 of incoming glassmaking material to be heated is fed to the upper end 15 of unit 7. Stream 9 is fed to one or more locations so that glassmaking material descends along the inner surface of wall 12. The glassmaking material is fed into space 21 at a rate such that it descends without overflowing at the top of unit 7. The wall 12 can be vertical or can slope such that the distance across space 21 closer to the upper end is larger than the distance across space 21 closer to the lower end. The glassmaking material is fed from above the inner surface of wall 12, near the inner surface. When baffles protruding into space 21 are in place as described below, the glassmaking material is preferably fed close enough to wall 12 so that it contacts the baffles as it descends. The baffles are preferably configured and arranged so as to confine the descending glassmaking material near wall 12 and to avoid dispersing the glassmaking material toward the zones of space 12 where hot flue gas stream 5 enters unit 7. Glassmaking material can be fed from all around the upper end of space 21, or from only one region or from more than one regions around the upper end (for instance, along only one or two sides of a rectangular unit).

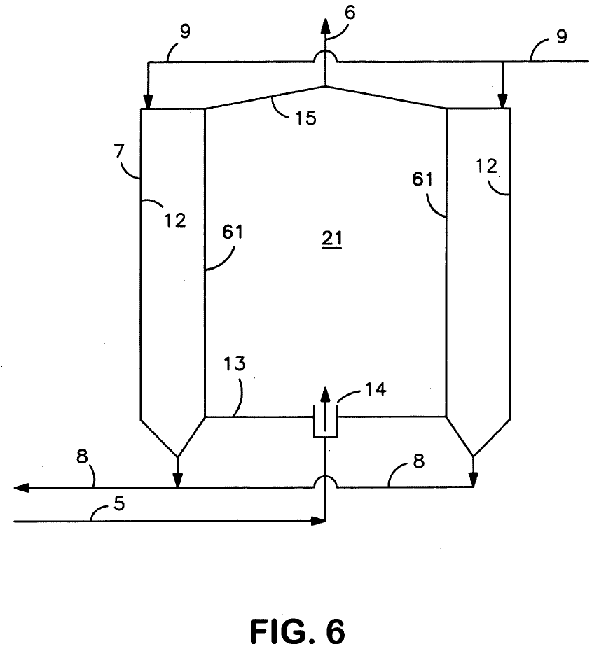

FIG. 6 depicts an alternative in which a barrier 61 completely separates the combustion products from the glassmaking material, so that all heat transfer including the radiative heat transfer, is indirect. While the description herein describes operation in which some of the radiative heat exchange can be direct heat exchange, it should be noted that operation in which all radiative heat exchange is indirect is also a useful embodiment of this invention.

The glassmaking material is preferably of a size, ranging from small pieces of cullet down to finely divided particulate glassmaking material, such that the glassmaking material is able to flow downwardly under the influence of gravity.

As the glassmaking material passes downward through space 21, its temperature increases by virtue of the flow of heat from the hot combustion products that are in space 21 and passing through space 21. The thus heated glassmaking material exits heat exchange unit 7 as stream 8 which can then be fed to the glassmelting furnace.

Stream 6 of cooled combustion products exits the heat exchange unit 7, for example through upper end 15 in this example, at a temperature of typically 1400° F. or less, although the temperature at this point can be adjusted depending upon the operational characteristics of heat exchange unit 7 and depending on whether the operator wishes to pass this stream to another unit from which additional heat can advantageously be drawn from stream 6, such as another heat exchange unit which passes heat to incoming glassmaking material or to one or more streams of oxidant or fuel to be employed in the combustion that is carried out in glassmaking furnace 3 Heat exchange unit 7 can be constructed of any material that is capable of withstanding the temperatures encountered in the operation described herein. The wall and the upper and lower ends of unit 7 should be made of insulating ceramic materials. The upper end 15 may be flat or sloping as shown in FIG. 2. Nozzle 14 is preferably constructed of ceramic material that can withstand the temperature of the incoming hot combustion product stream.

The efficiency of heat transfer to the descending flow of glassmaking material can be enhanced by providing appropriate baffles such as downwardly concave angle irons disposed in the path of the descending material, to deflect the material from its downward path and to require it to take more time to move along the baffle surfaces, thereby increasing residence time in the space 21 and enhancing heat transfer. An example of heat exchangers using such baffles is described in U.S. Pat. No. 5,992,041.

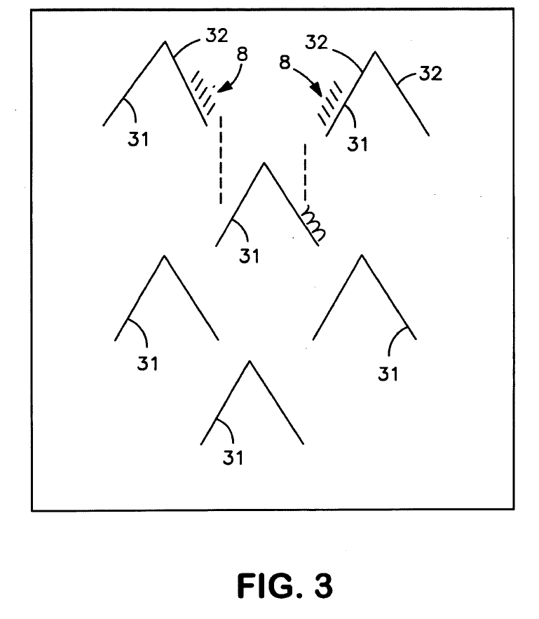

FIG. 3 illustrates suitable baffles and suitable location. The view in FIG. 3 is looking at an interior surface of a wall 12, seen from inside space 21. Each baffle 31 protrudes into space 21 from an inner surface of a wall 12. Each baffle 31 has a surface 32 which slopes downwardly so that material impinging on the top of the surface 32 either slides downward on that surface or on other material that has previously landed on that surface, or (less often) caroms off of surface 32 or off of material already on that surface. The baffles are preferably arrayed so that baffles that are adjacent to each other in a given row are spaced apart from each other, thereby permitting glassmaking material to pass between a pair of adjacent baffles, and are arrayed so that material passing through the space that is between a pair of baffles will strike a baffle that is below that space, as shown in FIG. 3. Preferably, a lip 34 is provided that extends a short distance above a surface 32, to help keep material from falling into the interior of space 21 off of the edge of the baffle that is closer to the interior of space 21. Effective heat transfer to the glassmaking material is obtained by also providing that the hot combustion products do not contact the glassmaking material while the temperature of the hot combustion products is at or above the temperature at which the glassmaking material becomes adherent.

Combustion of the fuel and oxidant produces stream 5 of hot gaseous combustion products which is removed from furnace 3 and fed to heat exchange unit 7, from which stream 6 of cooled gaseous combustion products emerges. Optional bypass stream 10 carries hot combustion products from stream 5 to join exit stream 6 without passing through heat exchange unit 7. Bypassing of a portion of stream 5 is typically required for air fired furnaces or partially oxy-fuel fired furnaces where the volume and the waste heat available in hot combustion products far exceed the amount of heat that can be absorbed by preheating the glassmaking material to the maximum preheat temperature limited by stickiness problems of certain batch ingredients. Even for oxy-fuel fired furnaces using relatively high purity oxygen of 90% O₂ or greater, partial bypassing of stream 5 may be required, depending on the furnace size and operating conditions, to control the temperature in heat exchanger unit 7. For example, a representative temperature of heat exchanger unit 7 can be monitored by one of more thermocouples placed in the interior of unit 7. The flow rate of bypass stream 10 can be adjusted by a damper (not shown) in stream 5. Thus, it is possible to control the temperature of unit 7 by adjusting the flow rate of bypass stream 10 as the operating conditions of a glass melting furnace changes and the feed rate of glassmaking material to heat exchanger unit 7 changes.

Stream 8 of heated glassmaking material to be fed to furnace 3 and melted in furnace 3 is obtained by passing glassmaking material fed as stream 9 through heat exchange unit 7. Optional bypass stream 11 denotes glassmaking material that is combined with heated glassmaking material in stream 8, to be fed also to furnace 3, but which is not passed through heat exchange unit 7. For example only cullet can be fed through heat exchanger unit 7 as stream 9 and can be combined with unheated batch material as bypass stream 11 to form stream 8. Stream 9 and optional stream 11 typically receive the glassmaking material from suitable bins and feeders of conventional design. In a preferred embodiment, the glassmaking material that is fed as stream 9 into heat transfer space 21 (as described below) is material (including a single substance or a mixture of substances) that becomes adherent at 1200° F. or higher, or even at 2000° F. or higher. Silica sand is such material. Then, if desired, the glassmaking material that is fed in bypass stream 11 and is not heated in unit 7 is material (including a single substance or a mixture of substances) that becomes adherent at a temperature below 1200° F., such as material containing niter and/or boron compound(s) used in manufacturing borosilicate glass. The materials that are not heated in unit 7 can optionally be heated without passing through space 21, provided that the material is not heated to a point at which it becomes adherent. When optional stream 11 is used, a mixing device (not shown) is normally required to combine and mix stream 8 and stream 11 and to achieve adequate homogeneity of glassmaking material before it is fed to furnace 3.

Determination of the appropriate temperatures for operation of the unit 7 is based in part on the properties of the mixture of ingredients of the glassmaking materials that are fed through space 21 on their way to the glassmaking furnace. As is known in this field, those ingredients need to contain, or be capable upon application of high temperatures of being converted into, the desired glassmaking components, taking into account the composition of cullet, if any is present, and the composition of all batch components present. Suitable ingredients may include not only the aforementioned compounds but also fining agents and precursors such as (but not limited to) alkali silicates, carbonates, sulfates, nitrates and hydroxides, and alkaline earth metals silicates, carbonates, sulfates, nitrates and hydroxides, as well as hydrates of any of the foregoing. Typical components and ranges of the amounts thereof in various types of glass can be determined from published sources and from routine testing. For illustrative purposes, it can be mentioned that many types of glass may contain 55 wt. % to 85 wt. % silica (SiO_{2), a total of} 4.5 wt. % to 20 wt. % of Na₂O and K₂O, a total of 0.05 wt. % to 25 wt. % of CaO and MgO, and 0 to 15 wt. % of Al₂O₃, and optionally other components such as Fe₂O₃, PbO (used in crystal glass and lead crystal), B₂O₃ (in borosilicate glass), and/or compounds that are or that contain oxides of Ti, S, Cr, Zr, Sb and/or Ba.

Lower adherent temperatures (as that term is used herein) are generally associated with higher amounts of alkali and alkaline earth metal oxides, hydroxides, nitrates, carbonates, and sulfates.

For ingredients that become adherent at relatively lower temperatures (such as the ingredients used to make common soda lime glass or borosilicate glass), the temperature should not exceed 1300° F., preferably not exceed 1200° F. Since many different ingredients are used in glass making and the adherent characteristics of glassmaking materials not only depend on the ingredients and moisture content (with lower moisture content being preferred to help resist caking or fusing), but also on their particle size distributions and on the metals used for the baffles or other metals that come in contact with the heated glassmaking material, tests to determine the maximum temperature to avoid sticking problems should be conducted. A recommended test procedure is to heat 250 grams of the glassmaking material, which is in free-flowing particulate form at room temperature, to a given temperature in a metal container (or a crucible) preferably made of the same metal as the baffles that is to come in contact with the heated glassmaking material, and hold the heated material at that temperature for 30 minutes. The heated container is then inverted to assess the flowability characteristics of the material being thus tested. The lowest temperature at which at least 1% of the material adheres to the surface of the container after being subjected to these steps is defined as the “adherent temperature” of the material for the metal used for the container. The temperature of hot combustion products that contact the glassmaking material in unit 7 should not exceed the adherent temperature, and preferably should not exceed 100° F. below the adherent temperature. Satisfying these conditions ensure that glassmaking material will not become so hot that it softens and becomes sticky and then begins to adhere to baffles or plug passageways or openings instead of flowing freely.

These conditions are satisfied for any given set of operating conditions, by providing that the hot combustion products passing through space 21 do not contact the glassmaking material when the combustion products are at a temperature that would cause the glassmaking material to become adherent, while also providing that the heat flux (in units of energy per area of the descending flow of glassmaking material being heated per unit of time) to all of the exposed surface of the glassmaking material remains sufficiently low that the surface of the glassmaking material does not reach or exceed the temperature at which the glassmaking material becomes adherent. The heat flux and temperature distributions can be estimated by radiative and convective heat transfer calculations taking into account, among other things, the incoming temperature and flow rate of the stream of hot combustion products, the temperature and flow rate of the glassmaking material entering heat exchange unit 7, and the geometrical configuration of space 21. Accurate prediction of the temperature distribution, while achievable, is generally difficult and requires an application of a detailed mathematical heat transfer model for optimization.

Thus, a practical way to achieve useful operation of the radiative heat exchanger unit 7 is to provide a sufficiently high surface area of the descending flow of glassmaking material and a sufficiently large space 21 into which the combustion products are fed. The geometry of the space 21 is selected to allow good radiative heat exchange from the hot combustion products without causing the glassmaking material to become adherent.

For example the aspect ratio of a rectangular passageway, defined as the ratio of the vertical length of the passageway to the shorter side of the rectangle, is preferably less than 6 and more preferably less than 4. A preferred method is to introduce the combustion products near the center of the lower end 13 through which nozzle 14 passes so that the distance of even the hottest portion of the combustion products from the heat transfer walls is sufficiently large that the heat flux to the glassmaking material does not become too high that the temperature to which the glassmaking material is exposed becomes too high. Thus, the factors that can most readily be adjusted as determinative in providing operation according to this invention are the total surface area of the descending flow of glassmaking material in space 21, and the distance from the point or points at which the combustion products are hottest as they are fed into the heat exchange unit (typically this is at the nozzle or nozzles 14 when the hot combustion products are fed into the space 21 of the heat exchange unit through one or more nozzles) to the nearest point or points on the surface of the glassmaking material which are exposed to the hot combustion products.

Without intending to be bound by any particular explanation of the efficacy of this invention, it appears that the predominant mode of heat transfer from the combustion products to the glassmaking material in space 21 is radiative, although some contribution of convective heat transfer always exists. Thus, the calculations that are carried out to determine a heat transfer surface area and suitable location of the inlet nozzle or nozzles are those carried out in the characterization of radiative heat transfer.

The space 21 is configured so that at least a portion of the heat transfer in space 21 from the hot combustion products to the glassmaking material is direct radiative heat transfer, that is, a straight line can be drawn from the combustion products to the glassmaking material which does not pass through any solid barrier such as a wall. In one preferred embodiment, all the radiative heat transfer is direct under this definition.

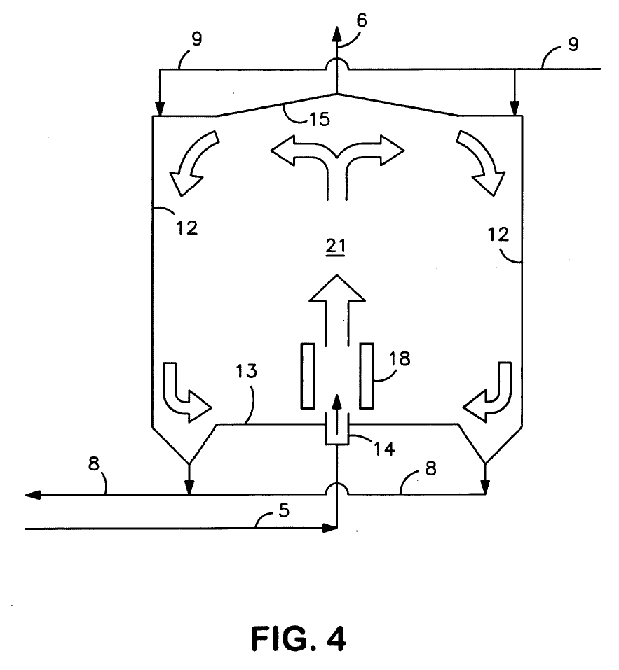

FIG. 4 illustrates another preferred embodiment of the present invention. FIG. 4 depicts the embodiment of FIG. 2, but to which has been added shadow wall 18. Shadow wall 18 is located between inlet nozzle 14 and the descending flow of glassmaking material. Shadow wall 18 extends from at or near the lower end 13, upwards into space 21. It does not extend the full distance to the upper end 15. Thus, even when a shadow wall 18 is present, there remains a region in space 21 where there is no barrier between the combustion products and the surface of the descending glassmaking material, so that direct radiative heat transfer can occur. The shadow wall 18 is made of suitable refractory material, such as high-temperature-tolerant ceramic materials, that can withstand the temperature of the incoming hot combustion product stream. Shadow wall 18 preferably has openings through it to only partially pass radiative heat flux from the hot combustion product stream toward the descending flow of glassmaking material, thus reducing the radiative heat flux in a controlled fashion. The openings can be circular or polygonal, or can be in the form of elongated slots. Generally, the openings can occupy from 10% to 90% of the surface of the shadow wall; the particular percentage can readily be determined experimentally. The openings can be uniformly spaced on the surface of the shadow wall, or one may provide fewer openings nearer to the bottom (i.e. nearer to the point where the hot combustion products enter the passageway) and more openings further from the bottom. Shadow wall 18 may also absorb heat from the hot combustion products, and reradiate the heat toward the surface of the glassmaking material. Shadow wall 18 enables the operator to reduce the overall size of heat exchange unit 7 by reducing the heat flux from the hottest region of the space 21 through which the combustion products are flowing, which is usually the region closest to where the hot combustion products enter space 21. The effective dimensions of a shadow wall 18, especially the number of openings and their dimensions, can readily be determined experimentally.

In another preferred embodiment, shadow wall 18 has no openings through its sides, so that it functions as a conduit bringing gaseous combustion products into space 21.

Referring again to FIG. 4, the arrows that appear therein illustrate that use of shadow wall 18 enables establishing a flow pattern of the hot combustion products within space 21 in which the hot combustion products upon first entering space 21 flow upwardly, radiatively transferring heat to the descending glassmaking material, and then are drawn downwardly through a region that is closer to the glassmaking material so that further radiative or convective heat transfer can occur. Thus, cocurrent flow of the combustion products relative to the flow of the glassmaking material occurs along the surface of the glassmaking material. The combustion products are then drawn through spaces or openings at the base of shadow wall 18, by the incoming stream of hot combustion products, thereby providing the driving force for this cycling flow pattern that is illustrated by the arrows. Since the cocurrent flow of the combustion products has been cooled by heat transfer to the glass making material either directly or indirectly through the barrier wall, mixing it into the incoming stream of hot combustion products helps to reduce the gas temperature of flowing out of the shadow wall.

The heated glassmaking material must be conveyed to a charger(s) of the glass furnace without losing significant heat to the surrounding. A preferred way is to locate unit 7 near a charger and at a height above the charge level and use an insulated chute for gravity feeding. Other preferred methods include a screw conveyor and a vibrating tray conveyor.

As noted above, one significant advantage of the present invention is that more of the energy content of the hot combustion products can be used to advantage, even though its temperature is higher as being obtained directly from the furnace without passing through a regenerator or a recuperator, without requiring any significant reduction in the temperature of the stream (prior to its entry into the heat exchange unit 7) such as by adding a diluent fluid stream or by passing through another heat exchanger.

The fact that the present invention can take advantage of an incoming combustion product stream having a higher temperature than prior practice thought could be employed to heat incoming glassmaking material also means that the temperature of the combustion product stream can still be high enough that this stream can be used for additional heat exchange, within space 21 or after it exits space 21. That is, heat exchange can occur within space 21 by direct contact of the combustion products with the glassmaking material provided that the combustion products are not so hot that the glassmaking material becomes adherent. As another example, combustion product stream 6 can be fed to a conventional heat exchanger that exchanges heat from a combustion product stream having a temperature on the order of 1000° F. or less, by indirect or direct convective heat exchange with incoming glassmaking material, or with oxidant or fuel to be subsequently combusted in the glassmelting furnace, or with other gaseous, liquid or solid material. As a further advantageous embodiment, the glassmaking material that is fed as stream 9 can have already been heated, for instance by passage through such a conventional convective heat exchange unit, before it is fed as stream 9 to the heat exchange unit described herein. The heat exchange can be with cooled but still heat-bearing combustion products, or with a stream of other hot material.

The stream of cooled combustion products emerging from heat transfer unit 7, or from a subsequent heat exchanger, can, if desired, be subjected to treatment steps that may be desirable or necessary before the stream is discharged to the atmosphere or employed as a feed stream to a chemical processing stage. For instance, the stream can be passed through an electrostatic precipitator or equivalent apparatus to remove fine particulate contaminants. The stream can be treated to remove gaseous atmospheric pollutants such as sulfur oxides, such as by contacting the stream with a suitable absorbent or reactant such as Ca(OH)₂ or sodium carbonate.

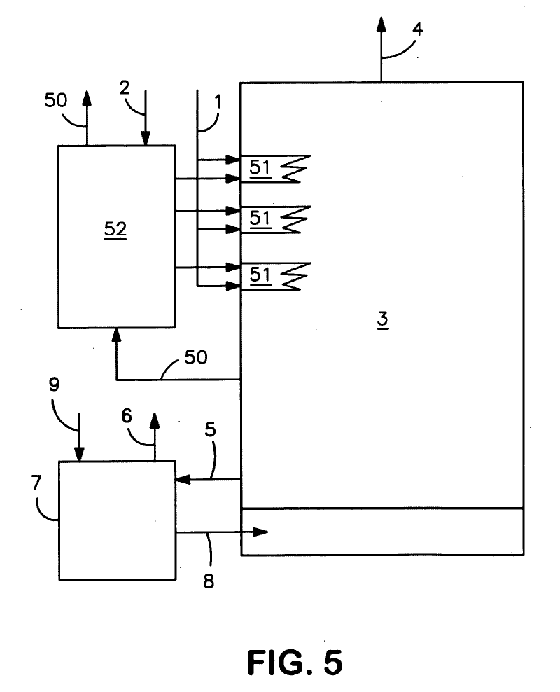

Turning to FIG. 5, which represents the glassmelting furnace coupled to an indirect heat exchanger 52 and a radiative heat exchanger unit 7, preferred operation of this furnace takes into account overall heat balance and the characteristics of efficient heat transfer in heat exchanger 52. This operation then provides many useful results.

The flow split ratio of the hot flue gas going into heat exchanger(s) 52 and into radiative heat exchange unit(s) 7 can be varied to optimize the overall heat recovery efficiency. For a retrofit application to an existing regenerative furnace such as is shown in FIG. 1, about 10 to 40%, preferably about 15 to 30%, of the total flue gas is introduced into a unit 7, bypassing the existing regenerators, recuperators, or other indirect heat exchangers present. Clogging of passages in such indirect heat exchangers is a common problem especially as time in use passes following the start of a new campaign of heat exchanger(s) 52. Often the furnace firing capacity has to be reduced because of the reduced combustion air capacity through these passages. The present invention offers a synergistic solution to this problem and, at the same time, improves the furnace productivity and reduces the fuel consumption. By extracting a portion of the hot combustion products that would otherwise be fed through these passages, the gas flow through the clogged passages is reduced. Also, since fuel consumption is reduced by preheating the glassmaking material (batch/cullet), the combustion air flow rate through the passages is proportionally reduced.

The present invention can be combined with partial conversion of the furnace to oxy-fuel combustion where one or two pairs of regenerator ports closest to the charge end of the furnace are closed and replaced with one to two pairs of oxy-fuel burners. One to two flue ports are placed in the same area to extract hot flue gas into one to two radiative heat exchange units 7. In the present invention, less furnace heating is required near the charger for the same glass pull since the batch/cullet is already preheated before they are fed into the furnace and the batch surface is more quickly glazed inside the furnace.

The preferred amount of hot combustion products extracted from the furnace is determined by the desired maximum preheat temperature of the glassmaking material in the radiative unit 7. For common soda lime glass furnaces, the maximum preheat temperature is about 1300 F due to the tendency of such materials to be adherent at higher temperatures. Preferably the preheat temperature is between 600 and 1300° F. More preferably the preheat temperature is between 700 and 1100° F. For improved heat recovery efficiency, the unit 7 should be designed to cool the flue gas to below 700° F., preferably below 550° F.

### EXAMPLE

Table 1 shows an illustrative comparison of the energy balances of (Case 1) 450 short tpd regenerative container glass melting furnace with five ports to a regenerative-type indirect heat exchanger, (Case 2) the same furnace with a conventional batch cullet preheater to preheat batch/cullet to 572° F., and (Case 3) a modified 450 short tpd regenerative container glass melting with the present invention to preheat batch/cullet to 932° F. 50-50 mixture of batch and cullet is assumed in all cases. In Case 3 a portion of the flue gas from the air fired glass melting furnace is extracted and directly introduced into a radiative unit 7 to preheat the glassmaking material, preferably to 600 to 1200 F, and more preferably to 800-1100° F. The remaining flue gas passes through the existing indirect heat exchanger(s) e.g. regenerators or recuperators. The heat recovery efficiency of the regenerators or recuperators is improved as the ratio of the hot flue gas flow rate to the combustion air flow rate is reduced and approaches a more optimum condition. As a result the flue gas temperature leaving the regenerators or recuperators is reduced, resulting in a reduced heat loss to the flue gas. Specific assumptions and calculated results are provided below for comparison.

In Case 1, the flue gas enters the regenerator at 2850° F. and leaves at 900° F. The air preheat temperature after the regenerator is 2300° F. In Case 2, the flue gas enters the regenerator at 2850° F. and leaves at 854° F. due to an efficiency gain from reduce flow rates of flue gas and combustion air from fuel reduction. The air preheat temperature after the regenerator is 2300° F. The flue gas then enters a downstream conventional BCP and leaves the BCP at 510° F. by preheating the batch/cullet from 77° F. to 572° F. In Case 3, the first pair of regenerator ports, i.e., NO. 1 ports, are closed and 25% of the furnace flue gas is directly fed into the batch/cullet preheater of the present invention and the remaining 75% is fed into the remaing four ports of the existing regenerators. The flue gas enters the regenerator at 2850° F. and leaves at 402° F. due to the reduction in the hot flue gas flow rate and also an efficiency gain from reduce flow rates of flue gas and combustion air. The flue gas entering the radiative heat exchange unit 7 of the present invention leaves it at 536° F. by preheating the batch/cullet glassmaking material from 77° F. to 932° F.

TABLE 1

| | | CASE 2 | CASE 3 |
|---|---|---|---|
| | CASE 1 | PH | PH |
| | Baseline | T = 572° F. | T = 932° F. |
| ENERGY INPUT | | | |
| (MMBTU/TON) | | | |
| FUEL | 3.91 | 3.32 | 3.04 |
| OXIDANT PREHEAT | 1.84 | 1.56 | 1.40 |
| BATCH/CULLET PREHEAT | 0.00 | 0.28 | 0.47 |
| TOTAL INPUT | 5.75 | 5.16 | 4.91 |
| ENERGY OUTPUT | | | |
| (MMBTU/TON) | | | |
| ENERGY TO GLASS | 1.49 | 1.49 | 1.49 |
| FLUE LOSSES (TOTAL) | 3.50 | 2.91 | 2.68 |
| WALL HEAT LOSSES | 0.76 | 0.76 | 0.74 |
| (TOTAL) | | | |
| TOTAL OUTPUT | 5.75 | 5.16 | 4.91 |

As shown in the table above, the fuel requirement is reduced from 3.91 MMBtu/ton for the baseline Case 1, to 3.32 MMBtu/ton with a conventional batch/cullet preheater (Case 2), to 3.04 MMBtu/ton with the present invention.

The parallel heat recovery integration method of the present invention (Case 3) is clearly more efficient and economic compared to the conventional sequential heat recovery integration method (Case 2) where the total flue gas volume first passes through the regenerators and the remaining sensible heat in the cooled flue gas is recovered in a downstream batch-cullet preheater. This invention enables a higher preheat temperature for batch/cullet and, hence, improves the energy efficiency of air fired glass melting furnaces and hybrid furnaces fired both air and oxygen.

The present invention is particularly useful in that the radiative heat exchange unit 7 can take the hot flue gas at about 2500˜2700° F. and directly cool the hot flue gas, without dilution air or water, to about 1400-2000° F.

What is claimed is:

1. A glassmelting method comprising
(A) passing heated glassmaking material into a glassmelting furnace;
(B) combusting fuel with gaseous oxidant having an overall average oxygen content of at least 20.9 vol. % oxygen to produce heat for melting said heated glassmaking material in said glassmelting furnace and produce hot combustion products having a temperature greater than 1800° F.;
(C) obtaining first and second streams of hot combustion products from said furnace;
(D) feeding glassmaking material into a first heat exchange unit comprising a lower end, an upper end, and sides enclosing a heat transfer space between said upper and lower ends so that said glassmaking material descends along the inner surface of a side of said heat exchange unit;
(E) feeding said first stream of combustion products into said first heat exchange unit, wherein the temperature of said hot combustion products entering said heat exchange unit is at least 1800° F., and flowing said hot combustion products through said heat transfer space and out of said heat exchange unit,
wherein said hot combustion products heat said glassmaking material in said unit by heat exchange at least part of which is radiative heat exchange,
wherein said hot combustion products do not contact said glassmaking material within said heat transfer space while they are at a temperature at which the glassmaking material would become adherent if it contacts said hot combustion products,
(F) feeding said second stream of combustion products through a second heat exchanger wherein it exchanges heat by indirect heat exchange to said gaseous oxidant; and
(G) providing glassmaking material heated in step (E) as heated glassmaking material that is passed to the furnace in step (A), and providing gaseous oxidant that is heated in step (F) as gaseous oxidant that is combusted in step (A).

2. A method according to claim 1 wherein at least a portion of said radiative heat exchange in step (E) is direct radiative heat exchange.

3. A method according to claim 1 wherein all of said radiative heat exchange is indirect radiative heat exchange.

4. A method according to claim 1 wherein the hot combustion products fed in step (E) into said lower end of said heat exchange unit have a temperature of at least 2000° F.

5. A method according to claim 1 wherein the hot combustion products fed in step (E) into said lower end of said heat exchange unit have a temperature of at least 2200° F.

6. A method according to claim 1 wherein the oxidant combusted in step (B) has an overall average oxygen content of at least 23 vol. % oxygen

7. A method according to claim 1 wherein the oxidant combusted in step (B) has an overall average oxygen content of at least 25 vol. % oxygen

8. A method according to claim 1 wherein said heat exchange unit comprises a shadow wall that reduces the direct radiative heat transfer from said hot combustion products to said glassmaking material.

9. A method according to claim 1 wherein before said glassmaking material is fed into said upper end of said heat exchange unit it is heated in another heat exchanger by direct or indirect heat exchange.

10. A method according to claim 1 wherein said combustion products after flowing out of said heat transfer space are cooled in another heat exchanger by direct or indirect heat exchange.

11. A method according to claim 1 wherein said glassmaking material that is fed in step (D) becomes adherent at a temperature of 1200° F. or higher.

12. A method according to claim 1 wherein said glassmaking material that is fed in step (D) becomes adherent at a temperature of 1800° F. or higher.

13. A method of modifying a glassmelting furnace, comprising
providing a glassmelting furnace wherein fuel and gaseous oxidant having an oxygen content of at least 20.9 vol. % can be combusted to produce heat for melting glassmaking material in said furnace and produce hot gaseous combustion products, and a first heat exchanger coupled to the glassmelting furnace through which said hot combustion products can pass and through which said gaseous oxidant to be combusted in said furnace can pass and be heated by indirect heat exchange from said hot combustion products;
coupling to said glassmelting furnace a second heat exchanger comprising a lower end, an upper end, and sides enclosing a heat transfer space between said upper and lower ends so that hot combustion products from said furnace can pass through said space and glassmaking material can pass through said space along an inner surface of a side of said space and can then pass into said furnace, wherein said space is of sufficient size that hot combustion products passing through said space heat glassmaking material passing along an inner surface of said sides by heat exchange at least part of which is radiative heat exchange but do not contact said glassmaking material within said heat transfer space while they are at a temperature at which the glassmaking material would become adherent if it contacts said hot combustion products, and
providing one or more controllable dampers that can alter the volumes of said combustion products that are fed to said first heat exchanger and to said second heat exchanger.
